(19) United States
(12) Patent Application Publication
(10) Pub. No.: US 2018/0248372 A1
(43) Pub. Date: Aug. 30, 2018

(54) POWER STORAGE SYSTEM AND POWER CONDITIONER

(71) Applicant: OMRON Corporation, KYOTO (JP)

(72) Inventors: Hirokazu EHARA, Ibaraki-shi, OSAKA (JP); Kenji KOBAYASHI, Moriyama-shi, SHIGA (JP); Kunio AONO, Hirakata-shi, OSAKA (JP); Kosuke NOMURA, Kusatsu-Shi, SHIGA (JP)

(73) Assignee: OMRON Corporation, KYOTO (JP)

(21) Appl. No.: 15/750,841

(22) PCT Filed: Dec. 6, 2016
(86) PCT No.: PCT/JP2016/086201

§ 371 Date: Feb. 7, 2018

(30) Foreign Application Priority Data
Mar. 11, 2016 (JP) 2016-048371

(51) Int. Cl. H02J 3/24; H02J 7/00; H02J 3/38; H02J 7/35; H02J 3/32

(52) U.S. Cl. CPC H02J 3/24; H02J 7/0013; H02J 3/32; H02J 7/35; H02J 3/383

(57) ABSTRACT

As having a charge/discharge control function of storage batteries, when a plurality of power conditioners having a same basic switching period are installed together, hunting of charging/discharging power of the storage battery connected to each power conditioner is suppressed. Execution periods of control processes performed by control units 14 of a plurality of power conditioners 10 that have a function of controlling charging and discharging of storage batteries 25 are changed from basic switching periods so as to be different from each other.

### TECHNICAL FIELD

The present invention relates to a power storage system and a power conditioner.

### BACKGROUND ART

A hybrid type power conditioner (for example, refer to Patent Literature 1) capable of converting electric power obtained by a solar cell array into an alternating current (AC) and supplying the converted electric power to an AC load and/or a power system and charging surplus electric power to a storage battery has been put into practice.

### CITATION LIST

### Patent Literature

Patent Literature 1

Japanese Patent Application Laid-Open No. 2012-222908

### SUMMARY OF INVENTION

### Technical Problem

There is a limit on capacity of a solar cell array or a storage battery that can be connected to a hybrid type power conditioner. Therefore, it is considered to install a plurality of hybrid type power conditioners in parallel in order to increase the number of solar cell arrays or increase an amount of electric power that can be stored. However, the inventors of the present invention found that, if a hybrid type power conversion device with the same basic switching period is installed, charge/discharge power (mainly charge/discharge current) of a storage battery is hunted relatively large in a short period. Furthermore, the inventors of the present invention found that the same phenomenon also occurs in a power conversion device for a storage battery.

If a storage battery is used in a state in which charge/discharge power is largely hunted in a short period, a lifetime of a storage battery tends to be short. Therefore, it is desirable that hunting of charge/discharge power of the storage battery can be prevented even when a plurality of power conditioners are installed in parallel.

Accordingly, an object of the present invention is to provide a power storage system including a plurality of power conditioners, in which hunting of charge/discharge power of a storage battery connected to each power conditioner can be suppressed, and a power conditioner capable of being used as a constituent element of such a power storage system.

### Solution to Problem

The inventors of the present invention found, a result of keen research, that when a plurality of power conditioners with the same basic switching period are installed, a slight difference (a difference of about 20 ppm or less) occurs in a control period of each power conditioner due to individual differences of crystal oscillators of microcontrollers used in the power conditioners, and thus charge/discharge power of the control period is hunted. Furthermore, the inventors of the present invention found that the hunting of charge/discharge power of a storage battery connected to each power conditioner can be suppressed if a control period is differentiated more largely.

For this reason, the present invention can adopt a configuration of a power storage system including a plurality of power conditioners having the same basic switching period and connected to a power system and an alternating current (AC) load, wherein: each of the plurality of power conditioners comprises: a power conversion unit capable of supplying electric power from the power system to the AC load and/or a storage battery connected to the own power conditioner and supplying electric power charged to the storage battery and electric power from the power system to the AC load or supplying only the electric power charged to the storage battery to the AC load; and a control unit configured to periodically perform a control process of controlling the power conversion unit so that a target amount of electric power is transmitted and received between the plurality of power conditioners and the power system based on a magnitude of an input/output current flowing between the plurality of power conditioners and the power system, in which an execution period of the control process is able to be changed from the basic switching period, and wherein the execution periods of the control processes by the plurality of control units in the plurality of power conditioners are changed to be different from each other.

The storage battery connected to its own power conditioner in the present invention may be a storage battery accommodated in a housing of its own power conditioner or connected to its own power conditioner directly or via a bidirectional DC/DC converter.

The control unit of each power conditioner according to the present invention may have a function of changing the execution period of the control process to a period associated with unique information of its own power conditioner. In this case, the unique information may be a unit number assigned to each power conditioner when an operation of the power storage system starts.

Each power conditioner of the power storage system of the present invention may further include a setting change unit configured to change the execution period of the control process by the control unit. The setting change unit may change the execution period of the control process by the control unit based on information collected from each power conditioner (for example, a serial number) even when the execution period of the control process by each control unit is changed based on information set by a user (owner or constructor of the power storage system).

Also, the power conversion unit of each power conditioner of the power storage system of the present invention may have a function of supplying electric power from the power generator to the AC load and/or the power system. The control unit of each power conditioner may be a unit capable of changing the execution period of the control process to the basic switching period by a time corresponding to an integral multiple of a minimum resolution of a clock obtained by dividing a period of a crystal oscillator.

A power conditioner of the present invention connected to a power system and an AC load comprises: a power conversion unit capable of supplying electric power from the power system to a storage battery connected to the AC load and/or its own power conditioner and supplying electric power charged to the storage battery and electric power from the power system to the AC load or supplying only the electric power charged to the storage battery to the AC load; and a control unit configured to periodically perform a control process of controlling the power conversion unit so that a target amount of electric power is transmitted through the power line based on a magnitude of an input/output current flowing through a power line to the power system, in which an execution period of the control process is able to be changed from the basic switching period.

If a plurality of power conditioners are used, a power storage system in which charge/discharge power of a storage battery connected to each power conditioner is not substantially hunted can be constructed.

### Advantageous Effects of Invention

According to the present invention, a power storage system including a plurality of power conditioners with the same basic switching period, in which hunting of charge/discharge power of a storage battery connected to each power conditioner can be suppressed, and a power conditioner capable of being used as a constituent element of such a power storage system can be provided.

### BRIEF DESCRIPTION OF DRAWINGS

FIG. 1 is a configuration diagram of a power storage system according to an embodiment of the present invention.

FIG. 2 is a diagram for describing a configuration of each power conditioner included in the power storage system according to the embodiment.

FIG. 3 is a diagram for describing experimental results.

FIG. 4 is an enlarged diagram of BATP2 shown in FIG. 3.

FIG. 5 is a diagram for describing adjustment amount information.

FIG. 6 is a diagram for describing experimental results concerning the power storage system according to the embodiment.

### DESCRIPTION OF EMBODIMENTS

An embodiment of the present invention will be described below with reference to the drawings.

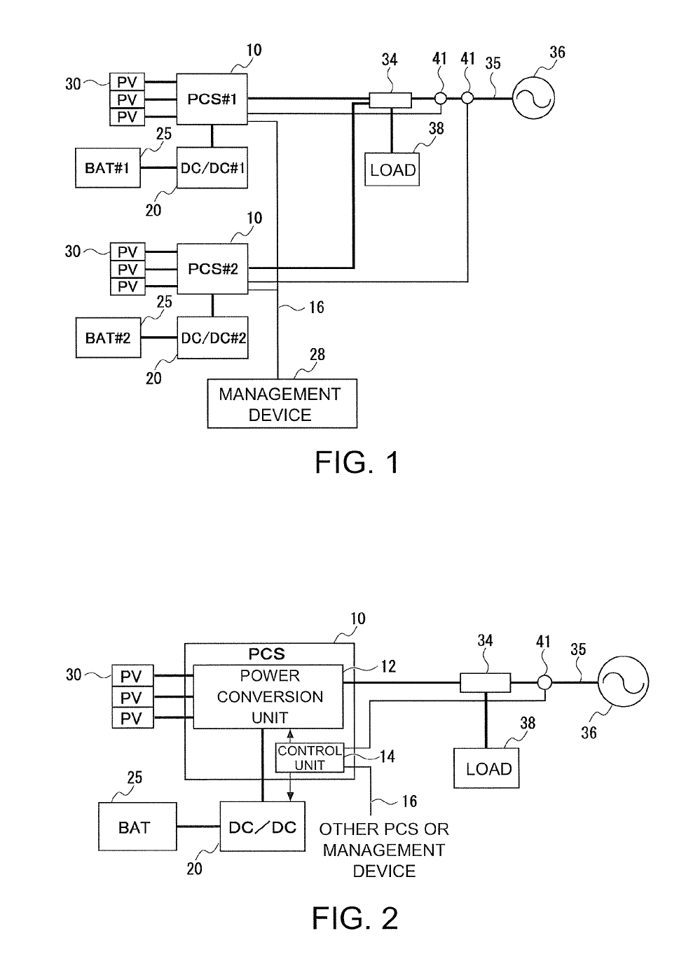

FIG. 1 is a configuration diagram of a power storage system according to the embodiment of the present invention. FIG. 2 is a diagram for describing a configuration of each power conditioner 10 included in the power storage system. First, the outline of the power storage system according to the embodiment will be described with reference to the drawings.

As shown in FIG. 1, the power storage system according to the embodiment includes a plurality of (two in the drawings) power conditioners (PCS) 10 connected to a power system 36 and an alternating current (AC) load 38 via a distribution board 34 and a management device 28 connected to each of the power conditioners 10 through a communication line 16.

The power conditioner 10 is a hybrid type power conversion device connected to each storage battery (BAT) 25 via a bidirectional DC/DC converter (DC/DC) 20 and connected to a solar cell (PV) 30.

As shown in FIG. 2, the power conditioner 10 includes a power conversion unit 12 connected to the solar cell 30, the bidirectional DC/DC converter 20, and the distribution board 34 and a control unit 14.

The power conversion unit 12 is a unit combining a plurality of switching elements, a reactor, or the like so as to take one of the states as exemplified below:
a state in which electric power from the power system 36 is supplied to the AC load 38 and/or the storage battery 25.
a state in which electric power from the storage battery 25 and electric power from the power system 36 is supplied to the AC load 38 or only the electric power from the storage battery 25 is supplied to the AC load 38.
a state in which electric power from the solar cell 30 is supplied to one or more of the storage battery 25, the AC load 38, and the power system 36.

The control unit 14 is a unit configured to control the power conversion unit 12 and the bidirectional DC/DC converter 20. The control unit 14 is constituted of a processor (a microcontroller in the embodiment), a gate driver IC, or the like. As shown in FIG. 2, an output of a current sensor 41 attached to a power line 35 connecting the distribution board 34 and the power system 36 is input to the control unit 14. In addition, an output voltage of the solar cell 30, a voltage (not shown) of the power conversion unit 12 on the distribution board 34 side, and the like are also input to the control unit 14. As shown in FIG. 1, the same number of current sensors 41 as the number of power conditioners 10 are attached to the power line 35 and outputs of different current sensors 41 are input to a plurality of control units 14 (power conditioners 10) in the power storage system.

As shown in FIGS. 1 and 2, the management device 28 is a kind of computer connected to each control unit 14 in each of the power conditioners 10 through the communication line 16. The management device 28 has a function of collecting information on an operation condition (electric power generation of the solar cell 30 or the like) from each power conditioner 10 and internally storing the information or a function of displaying the information stored therein in various forms. Furthermore, the power storage system is configured as a system in which each power conditioner 10 is identified using a unit number. When an operation of the power storage system is started (installed), a unit number (a serial number starting with “0” in the embodiment) is set for each power conditioner 10 using the management device 28.

The power storage system according to the embodiment will be described in more detail below.

The control unit 14 in the power conditioner 10 is a unit configured to periodically perform a control process for controlling the power conversion unit 12 and the bidirectional DC/DC converter 20 based on an output of the current sensors 41 and the like. Here, controlling the power conversion unit 12 and the bidirectional DC/DC converter 20 means performing on/off control (pulse width modulation (PWM) control) on a plurality of switching elements in the power conversion unit 12 and the bidirectional DC/DC converter 20.

In the control process performed by the control unit 14, the control process for outputting (discharging) a certain amount of electric power to the storage battery 25 or the control process for inputting (charging) a certain amount of electric power to the storage battery 25 is provided. The control process, which is performed by the control unit 14, involving charging/discharging of the storage battery 25 (hereinafter referred to as storage battery control process) is a process in which charging/discharging power of the storage battery 25 is hardly hunted if the power conditioner 10 is independently used.

Here, when a plurality of power conditioners 10 are connected to the same distribution board 34 and default storage battery control process is performed by each control unit 14, it is seen that charging/discharging power of each storage battery 25 is hunted. The default storage battery control process is a storage battery control process in which an execution period (hereinafter also referred to as a “control period”) is a basic switching period serving as a period at the time of factory shipment.

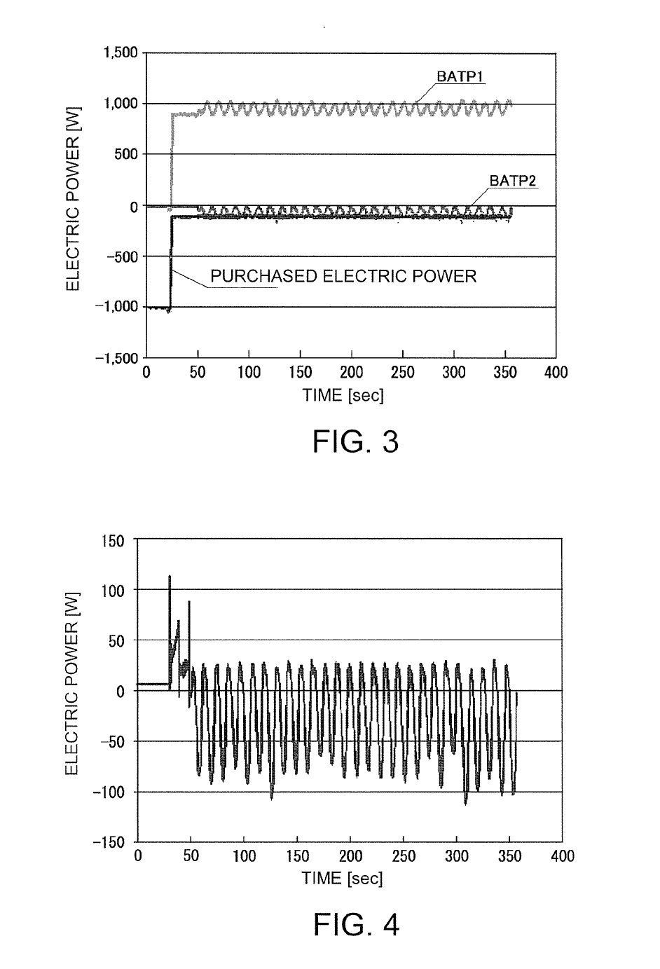

Specifically, experimental results illustrated in FIGS. 3 and 4 are obtained. The experimental results illustrated in FIG. 3 are obtained by connecting two power conditioners 10 from which the solar cell 30 is removed to a simulation system configured to simulate the power system 36, setting a target value of purchased electric power (electric power input from the simulation system) to 100 W, setting a power consumption due to the AC load 38 to 1000 W, and performing default storage battery control process on each control unit 14. In FIG. 3, BATP1 is the input/output electric power of one storage battery 25 and BATP2 is the input/output electric power of the other storage battery 25. In FIG. 3, electric power output from the storage battery 25 is indicated as positive and electric power input to the storage battery 25 is indicated as negative. Furthermore, FIG. 4 is an enlarged diagram of BATP2 shown in FIG. 3.

As is apparent from FIG. 3, when the plurality of power conditioners 10 are connected to the same distribution board and the default storage battery control process is performed on each control unit 14, the charging/discharging power (BATP1 or BATP2) of each storage battery 25 is hunted relatively large in a short period. The levels of BATP1 and BATP2 are largely different because the power conditioner 10 is configured as a device configured to determine/control the charging/discharging power of the storage battery 25 without considering the charging/discharging power of the storage battery 25 in the other power conditioner 10 and there are individual differences in the current sensors 41.

When such a phenomenon, particularly a phenomenon in which charging and discharging are alternately repeated like in BATP2 (refer to FIG. 4) occurs, the lifetime of the storage battery 25 tends to be short. For this reason, earnest research has been conducted to clarify the cause of this phenomenon. The inventors of the present invention found that when a plurality of power conditioners having the same basic switching period are installed, a slight difference (normally, a difference of about 20 ppm or less) occurs in a control period of each control unit due to individual differences of crystal oscillators in control units (in microcontrollers or the like) of power conditioners, and thus charging/discharging power of a storage battery is hunted.

Also, the inventors of the present invention found that hunting of charging/discharging power of each storage battery can be supressed by causing a control period of each control unit to fluctuate widely than the variation due to individual differences of the crystal oscillator. To be specific, a control period of a control unit is normally set to about 20 kHz to reduce the noise during operation, but they found that hunting of charging/discharging power of each storage battery can be reduced to a level sufficient for practical use if differences between control periods of two control units are all set to about 4 Hz or more.

Therefore, hunting of charging/discharging power can also be suppressed by setting the power storage system as a system in which a control period of each control unit 14 is set to satisfy the above conditions and then an operation is started. Here, hunting of charging/discharging power due to a setting error occurs is also thought to lead to deterioration of the storage battery 25, it is desirable that such setting is automatically performed.

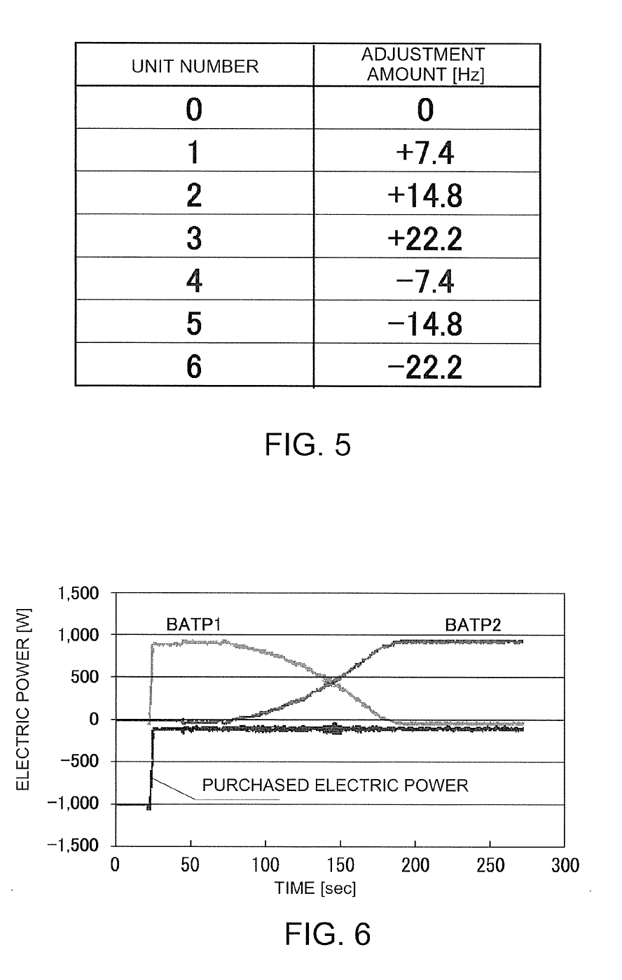

For this reason, the power conditioner 10 according to the embodiment, the control unit 14 is configured (programmed) to read an adjustment amount according to a unit ID assigned to the control unit 14 through an operation of the management device 28 and to perform a storage battery control process in a period obtained by adding the read adjustment amount from adjustment amount information indicating the correspondence between a unit ID and an adjustment amount of a control period as exemplified in FIG. 5.

Since control periods of two control units are different if the storage battery control process is performed in the period adjusted based on the adjustment amount information (FIG. 5), the hunting of the charging/discharging power of each storage battery 25 can be reduced to a level sufficient for practical use. Furthermore, the adjustment amount of FIG. 5 may be an integral multiple of a minimum resolution of a clock obtained by dividing a period of a crystal oscillator using a microcontroller. Here, because an optimum value of the adjustment amount depends on the design of the control unit 14, the optimum value is assumed to vary.

Specifically, the experimental results illustrated in FIG. 6 are obtained for the power storage system according to the embodiment. The experimental results of FIG. 6 were obtained by connecting two power conditioners 10 from which the solar cell 30 was removed to a simulation system configured to simulate the power system, setting a target value of electric power input from the simulation system to 100 W, setting a power consumption due to the AC load 38 to 1000 W, and performing the storage battery control process on each control unit 14 in the adjusted (changed) control period. The BATP1 decreases and BATP2 increases as time elapses because the power conditioner 10 is configured as a device configured to determine/control the charging/discharging power of the storage battery 25 without considering the charging/discharging power of the storage battery 25 in the other power conditioner 10 and there are individual differences in the current sensors 41. Furthermore, though switching storage battery discharged during the experiment from BATP1 to BATP2, it is confirmed that no hunting phenomenon occurred.

As described above, according to the power storage system of the embodiment, the hunting of the charging/discharging power of each storage battery 25 can be reduced to a level sufficient for practical use.

### Modification

Various modifications of the power storage system according to the above embodiment are possible. For example, although the above adjustment amount information (FIG. 5) is information directly indicating the correspondence between a unit ID and an adjustment amount of a control period, the adjustment amount information may be information indirectly indicating the correspondence between a unit ID and an adjustment amount of a control period or information directly/indirectly indicating the correspondence between a unit ID and an adjusted control period. Examples of information indirectly indicating the correspondence between a unit 10 and an adjustment amount of the control period can include information indicating a relationship between a unit ID and an amount of change of a setting value of a timer defining a control period (a positive or negative value to be added to the setting value of the timer). Examples of information indirectly indicating the correspondence between a unit ID and an adjusted control period can include information indicating a relationship between a unit ID and a setting value of a timer.

Also, the adjustment amount information directly/indirectly indicating the correspondence between a unit ID and an adjustment amount of a control period or an adjusted control period may be information embedded as program codes or data in a program or information read by a processor that has executed a program.

A function for acquiring a serial number of the other power conditioner 10 and determining an adjustment amount of a control period or an adjusted control period depending on an order of a serial number of its own power conditioner 10 in the sort result of the acquired serial number and the serial number of its own power conditioner 10 may be provided to the control unit 14. Furthermore, the power storage system according to the embodiment may be modified to a system in which a management device 18 determines an adjustment amount of a control period or the control period after adjustment from a magnitude relationship of a unit ID and a serial number and notifying the control unit 14 of each power conditioner 10.

The power storage system according to the embodiment may be modified to a system in which the power conditioner 10 is connected to a generator (a fuel cell or the like) other than the solar cell 30, a system in which a storage battery 25 is accommodated in a housing of the power conditioner 10, or a system in which the power conversion unit 12 also functions as a bidirectional DC/DC converter 20. In addition, a problem concerning the hunting of an amount of charging/discharging of the storage battery 25 is also generated in a power conditioner 10 which is not connected to a power generator when the power conditioners are arranged. Therefore, the power storage system according to the embodiment may be modified to a system including a plurality of power conditioners 10 configured to perform only charge/discharge control of the storage battery 25.

### REFERENCE SIGNS LIST

10 Power conditioner

12 Power conversion unit

14 Control unit

16 Communication line

20 Bidirectional DC/DC converter

25 Storage battery

28 Management device

30 Solar cell

34 Distribution board

35 Power line

36 Power system

38 AC load

41 Current sensor

1. A power storage system including a plurality of power conditioners having the same basic switching period and connected to a power system and an alternating current (AC) load, wherein:
each of the plurality of power conditioners comprises:
a power conversion unit capable of supplying electric power from the power system to the AC load and/or a storage battery connected to the own power conditioner and supplying electric power charged to the storage battery together with electric power from the power system to the AC load or supplying only the electric power charged to the storage battery to the AC load; and
a control unit configured to periodically perform a control process of controlling the power conversion unit so that a target amount of electric power is transmitted and received between the plurality of power conditioners and the power system based on a magnitude of an input/output current flowing between the plurality of power conditioners and the power system, wherein an execution period of the control process is able to be changed from the basic switching period, and
wherein the execution periods of the control processes by the plurality of control units in the plurality of power conditioners are changed to be different from each other.

2. The power storage system according to claim 1, wherein the control unit has a function of changing the execution period of the control process to a period associated with unique information of the own power conditioner.

3. The power storage system according to claim 2, wherein the unique information is a unit number assigned to each power conditioner when an operation of the power storage system starts.

4. The power storage system according to claim 1, wherein each power conditioner further comprises a setting change unit configured to change the execution period of the control process by the control unit.

5. The power storage system according to claim 1, wherein the power conditioner is able to be connected to a power generator, and
the power conversion unit has a function of supplying electric power from the power generator to one or more of the storage battery, the AC load, and the power system.

6. The power storage system according to claim 1, wherein the control unit is a unit capable of changing the execution period of the control process from the basic switching period by a time corresponding to an integral multiple of a minimum resolution of a clock obtained by dividing a period of a crystal oscillator.

7. A power conditioner having a basic switching period and connected to a power system and an AC load, the power conditioner comprising:
a power conversion unit capable of supplying electric power from the power system to a storage battery connected to the AC load and/or the own power conditioner and supplying electric power charged to the storage battery and electric power from the power system to the AC load or supplying only the electric power charged to the storage battery to the AC load; and
a control unit configured to periodically perform a control process of controlling the power conversion unit so that a target amount of electric power is transmitted through the power line based on a magnitude of an input/output current flowing through a power line to the power system, wherein an execution period of the control process is able to be changed from the basic switching period.

8. The power storage system according to claim 2, wherein the power conditioner is able to be connected to a power generator, and
the power conversion unit has a function of supplying electric power from the power generator to one or more of the storage battery, the AC load, and the power system.

9. The power storage system according to claim 3, wherein the power conditioner is able to be connected to a power generator, and
the power conversion unit has a function of supplying electric power from the power generator to one or more of the storage battery, the AC load, and the power system.

10. The power storage system according to claim 4, wherein the power conditioner is able to be connected to a power generator, and
the power conversion unit has a function of supplying electric power from the power generator to one or more of the storage battery, the AC load, and the power system.

11. The power storage system according to claim 2, wherein the control unit is a unit capable of changing the execution period of the control process from the basic switching period by a time corresponding to an integral multiple of a minimum resolution of a clock obtained by dividing a period of a crystal oscillator.

12. The power storage system according to claim 3, wherein the control unit is a unit capable of changing the execution period of the control process from the basic switching period by a time corresponding to an integral multiple of a minimum resolution of a clock obtained by dividing a period of a crystal oscillator.

13. The power storage system according to claim 4, wherein the control unit is a unit capable of changing the execution period of the control process from the basic switching period by a time corresponding to an integral multiple of a minimum resolution of a clock obtained by dividing a period of a crystal oscillator.

14. The power storage system according to claim 5, wherein the control unit is a unit capable of changing the execution period of the control process from the basic switching period by a time corresponding to an integral multiple of a minimum resolution of a clock obtained by dividing a period of a crystal oscillator.
